(19) United States
(12) Patent Application Publication
(10) Pub. No.: US 2023/0375111 A1
(43) Pub. Date: Nov. 23, 2023

(54) SPLICE FOR JOINING EXPANDED TUBE TO UNEXPANDED TUBE

(71) Applicant: Airsept, Inc., Atlanta, GA (US)

(72) Inventors: Aaron Becker, Atlanta, GA (US); Thomas M. Wall, Nashville, TN (US)

(21) Appl. No.: 18/319,438

(22) Filed: May 17, 2023

Related U.S. Application Data
(60) Provisional application No. 63/364,881, filed on May 17, 2022.

(51) Int. Cl. F16L 21/02; F16L 15/00

(52) U.S. Cl. CPC F16L 21/022; F16L 15/008

(57) ABSTRACT

A removable splice hermetically joins a tube with an expanded end to a tube with an unexpanded end. The splice is an assembly with a splice body, including opposite first and second externally threaded nipples; a nut threadedly engaging each nipple, each nut including a central opening through which an engaged portion of a tube is received; a spacer received in an expanded end of a first tube and a portion of the spacer extending from the expanded end; an anti-vibration tension ring surrounding a portion of the expanded end of the first tube; a sleeve surrounding a portion of the expanded end of the first tube; another anti-vibration tension ring surrounding a portion of the unexpanded end of the other tube; a seal surrounding the portion of the unexpanded end of the second tube.

### RELATED APPLICATION

This application is a nonprovisional and claims the benefit of priority of U.S. provisional application 63/364,881 filed May 17, 2022, the contents of which are incorporated herein by this reference.

### FIELD OF THE INVENTION

This invention relates generally to HVAC systems with copper tubing, and, more particularly, to a removable splice for hermetically joining a tube with an expanded end to a tube with an end that is sized to mate with the expanded end.

### BACKGROUND OF THE INVENTION

Air conditioning systems and heat pumps include a compressor with an inlet port and an outlet port through which refrigerant flows. Each port, the inlet and outlet, includes a service port valve, commonly referred to as a king valve. A typical service port valve includes a copper tube with an expanded end to which a copper line mates. The copper line has an outer diameter sized to fit into the expanded end. The mated ends are joined via brazing, i.e., melting and flowing a filler metal (i.e., solder) into the joint, with the filler metal having a lower melting point than the adjoining copper.

Brazing is not only cumbersome, but poses serious risks. In addition to a substantial risk of fire, particularly when flammable refrigerants, such as butane or propane, are used, there are risks of leakage and corrosion. A poor joint may be formed if enough clearance is not allowed for the filler metal to form a joint between the mated copper tubes, or the metal surfaces are unclean, or the wrong flux is used, or the surface area to be joined is not completely covered with flux before starting the brazing process, or tubes are joined with faulty alignment, or flux residue is not removed after the brazing process is complete, which can lead to weakened joints since the flux material is potentially corrosive. Additionally, a brazed joint is not easily removed.

Additionally, copper lines with expanded ends vary. Even the same diameter copper lines may have longer or shorter expanded ends. The length varies from one manufacturer to another.

A splice that avoids the risks and challenges of brazing is needed. The splice should allow joining an expanded end of a tube to an unexpanded end of a mating tube. The splice should accommodate expanded ends of varying length. The splice should accommodate tubes with imperfectly cut ends. The splice should consistently provide a reliable seal without risk of leakage or corrosion. The splice should be easy to install using conventional hand tools. The splice should be removable without damaging the joined tubes.

The invention is directed to overcoming one or more of the problems and solving one or more of the needs as set forth above.

### SUMMARY OF THE INVENTION

To solve one or more of the problems set forth above, in an exemplary implementation of the invention, a splice hermetically joins a tube with an expanded end to a tube with an unexpanded end. The splice is an assembly with a splice body, including opposite first and second externally threaded nipples; a nut threadedly engaging each nipple, each nut including a central opening through which an engaged portion of a tube is received; an anti-vibration tension ring surrounding a portion of the expanded end of the first tube; a sleeve surrounding another portion of the expanded end of the first tube; another anti-vibration tension ring surrounding a portion of the unexpanded end of the other tube; a seal surrounding the portion of the unexpanded end of the second tube. The seal and sleeve are both seals. One is referred to as a sleeve to distinguish it from the seal. The portion of the spacer extending from the expanded end of the first tube, and the first anti-vibration tension ring are contained in a first side of the splice body. The sleeve and second anti-vibration tension ring are contained in the second side of the splice body. The assembly is serviceable. It may be disassembled. Parts may be removed and replaced as needed.

In one embodiment, a splice is provided for hermetically joining a tube with an expanded end to a tube with an end that is sized to mate with the expanded end. The splice includes a splice body with a pair of opposed nipples, including a first nipple and a second nipple, each nipple being externally threaded, the splice body further including a first side and a second side

A first nut threadedly engages the first nipple. The first nut includes a first central opening sized to receive an expanded portion of a first tube and also includes a first compartment. A second nut threadedly engages the second nipple. The second nut includes a second central opening sized to receive an unexpanded portion of a second tube and also includes a second compartment. A spacer is received in the expanded portion of the first tube. A portion of the spacer extends from the expanded portion of the first tube. A first anti-vibration tension ring surrounds a portion of the expanded portion of the first tube. A sleeve surrounds another portion of the expanded portion of the first tube. A second anti-vibration tension ring surrounds a portion of the unexpanded portion of the second tube. A seal surrounds the portion of the unexpanded portion of the second tube. The portion of the spacer extending from the expanded portion of the first tube, and the sleeve are contained in the first side of the splice body. The sleeve is contained in the second side of the splice body. At least a portion of the first anti-vibration tension ring is contained in the first compartment of the first nut. At least a portion of the second anti-vibration tension ring is contained in the second compartment of the first nut.

Each antivibration tension ring includes a leading edge and a trailing edge opposite the leading edge, and a plurality of fingers defined between spaced apart parallel slots extending from the trailing edge to a point between the leading edge and the trailing edge. Each antivibration tension ring also includes an interior annular groove between the leading edge and the trailing edge (e.g., between the leading edge and the point between the leading edge and the trailing edge) configured to facilitate deflection of the plurality of fingers. An interior surface of each finger of the plurality of fingers includes knurls. The knurls may comprise ridges with a first face that is generally perpendicular to a central axis of the antivibration tension ring, and an opposite second face at an acute angle relative to the first face. Each antivibration tension ring includes a frusto-conical exterior trailing edge portion, an intermediate band, and a leading-edge annular band. The intermediate band is between the frusto-conical exterior trailing edge portion and the leading-edge annular band.

The first compartment of the first nut is sized and shaped to matingly receive the frusto-conical exterior trailing edge portion of the first antivibration tension ring. Likewise, the second compartment of the second nut is sized and shaped to matingly receive the frusto-conical exterior trailing edge portion of the second antivibration tension ring. When matingly received, the compartment is in direct contact with the frusto-conical exterior trailing edge portion of the antivibration tension ring over substantially the entire surface area of the compartment (e.g., over at least one half of its entire surface area).

### BRIEF DESCRIPTION OF THE DRAWINGS

The foregoing and other aspects, objects, features and advantages of the invention will become better understood with reference to the following description, appended claims, and accompanying drawings, where:

FIG. 1 is a first exploded perspective view of components of an exemplary splice assembly according to principles of the invention; and

FIG. 2 is a second exploded perspective view of components of an exemplary splice assembly according to principles of the invention; and

FIG. 3 is a section view of an exemplary splice assembly according to principles of the invention; and

FIG. 4 is a section view of a first splice body for an exemplary splice assembly according to principles of the invention; and

FIG. 5 is a section view of a second splice body for an exemplary splice assembly according to principles of the invention; and

FIG. 6 is a section view of a third splice body for an exemplary splice assembly according to principles of the invention; and

FIG. 7 is a profile view of an anti-vibration tension ring for an exemplary splice assembly according to principles of the invention; and

FIG. 8 is a section view of an anti-vibration tension ring for an exemplary splice assembly according to principles of the invention; and

FIG. 9 is a perspective view of an anti-vibration tension ring for an exemplary splice assembly according to principles of the invention; and

FIG. 10 is a section view of an anti-vibration tension ring for an exemplary splice assembly according to principles of the invention; and

FIG. 11 is a detail view of teeth of an anti-vibration tension ring for an exemplary splice assembly according to principles of the invention; and

FIG. 12 is a section view of a nut for an exemplary splice assembly according to principles of the invention; and

FIG. 13 is a section view of a seal for an exemplary splice assembly according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

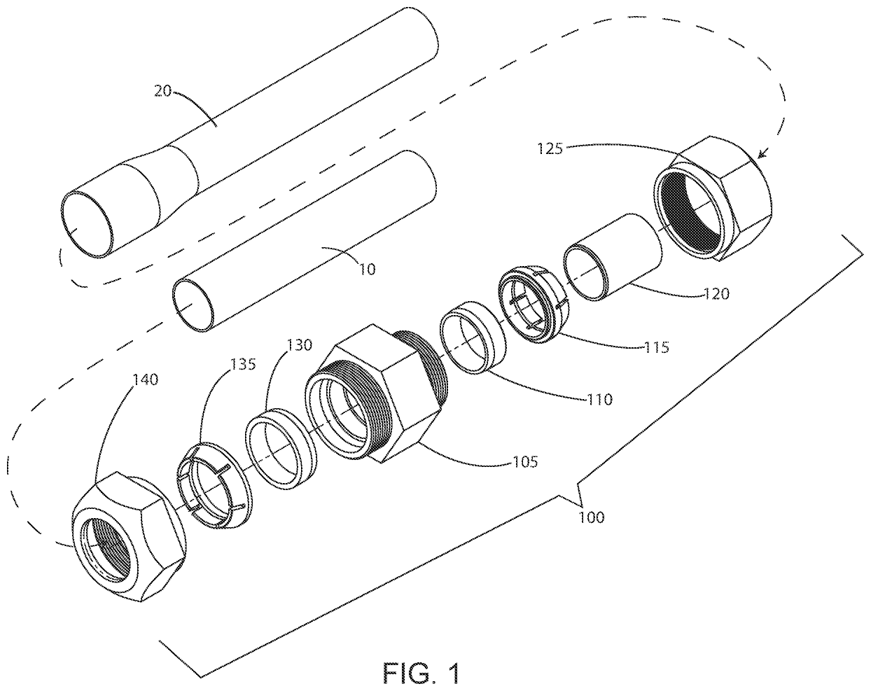

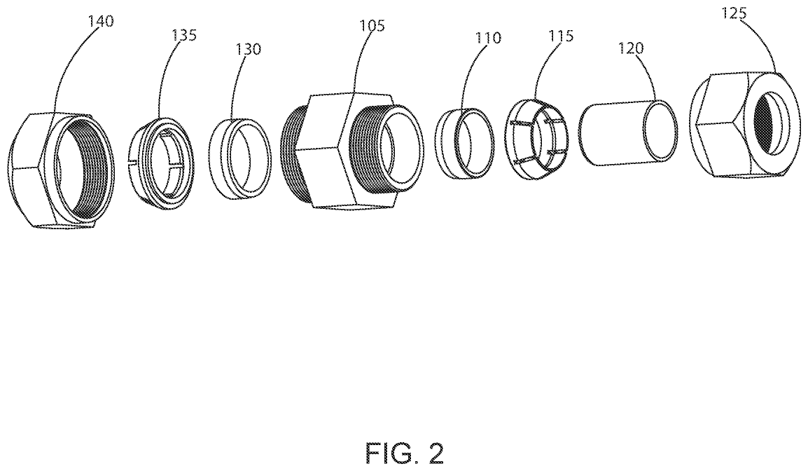

Referring to FIGS. 1-3, a splice 100 according to principles of the invention forms a hermetic seal between the ends of the joined tubes. The splice 100 is an assembly that includes a spacer 120, a splice nut 125 for the expanded side, a sleeve 110, an AVTR (anti-vibration tension ring) 115 for the side of the splice that mates with an expanded end of a first tube, and a splice body 105. This side of the splice 100 is referred to as the expanded side because it mates with a tube at an expanded end, such as the expanded end of tube 20 in FIG. 1.

The splice assembly 100 further includes a seal 130, an AVTR 135 and a nut 140 for the side of the splice that mates with the end of the second tube (e.g., an end of an unexpanded tube). This side of the splice is referred to as the standard side, because it mates with an end of a tube that is not expanded, such as tube 10 in FIG. 1. The end of the unexpanded tube could mate with and be joined to the expanded end of the other tube by brazing, if the splice assembly according to principles of the invention was not used.

Sleeve 110 and seal 130 are seals. Sleeve 110 is referred to as a sleeve, rather than as a seal, to distinguish it from seal 130. Sleeve 110 and seal 130 may be thought of as a first seal and a second seal.

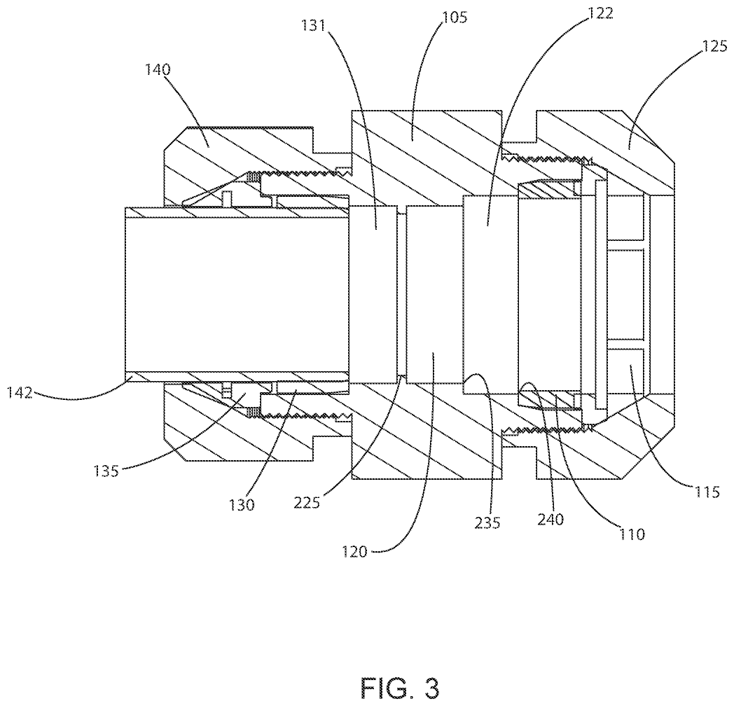

The spacer 120 is a tubular structure with an outer diameter that is about equal to the inner diameter of the expanded end of the tube to which the splice is joined. The spacer 120 fits into the expanded end of the tube. The fit may be snug, without appreciably resisting insertion and removal. As the spacer 120 is not brazed to the expanded end, there does not have to be sufficient space between the spacer 120 and the expanded end for solder to flow. The length of the spacer 120 may be slightly longer than the length of the expanded end, excluding the transition portion of the expanded end. When the spacer 120 is fully inserted into the expanded end, a portion of the spacer 120 may extend outwardly from the expanded end. In one embodiment, the outwardly extending distance about equals (but is not greater than) a distance between an internal flange of the splice body and a shoulder 235 (FIG. 3) of an intermediate counterbore. The edge of the spacer 120 abuts the internal flange 225. The spacer 120 provides structural support to the expanded end of the tube, preventing undesirable crushing, buckling and other deformations.

Each splice nut 125, 140 includes a nut body, a distal opening at one end of the nut body, and a proximal opening at the opposite end of the nut body. At least a portion of the outer periphery of the nut body has a shape that can be engaged with a standard wrench, such as a hexagonal cross section shape. A portion of the nut body is internally threaded. The threaded portion extends from the proximal opening to, but not including, the distal opening. Excluding the distal opening, the nut body (including the proximal opening) has a consistent diameter suitable for threadedly engaging an externally threaded portion of the splice body. The diameter of the distal opening is less than the diameter of the proximal opening. The diameter of the distal opening is approximately equal to the outer diameter of the end of the corresponding tube, allowing the distal opening to slide over the end of the tube. Thus, the diameter of the distal opening for the splice nut 125 used on the expanded side is greater than such diameter for the nut 140 used on the standard side.

The sleeve 110 is a band-like structure with an internal diameter that is approximately equal to the outer diameter of the expanded portion of the tubing. The sleeve 110 slides onto the expanded portion of the tubing. The sleeve 110 occupies space between the interior of the splice body 105 and a shoulder, annular flange or other stop within the body 105. The thickness of the sleeve 110 is sufficient to occupy the space, without interfering with installation.

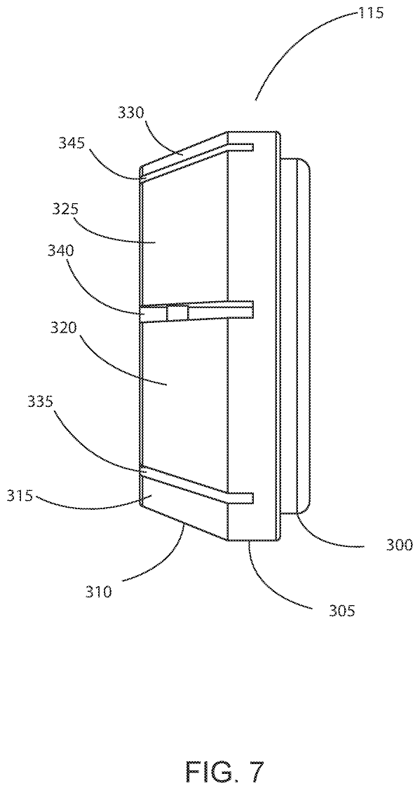

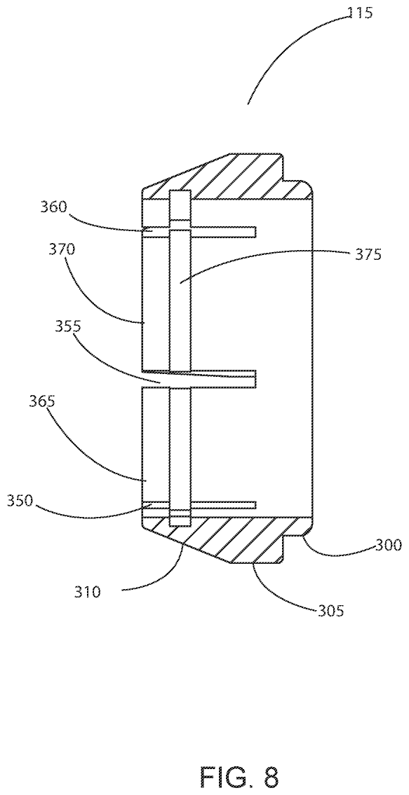

Each AVTR 115, 135 is a ring-like structure. Referring to FIGS. 7 and 8, each AVTR 115, 135 includes an externally chamfered trailing edge (i.e., edge facing away from splice body) portion 310, an intermediate band 305, a leading-edge annular flange 300, an interior annular groove 375 and a plurality of fingers 315, 320, 325, 365, 370 defined between evenly spaced apart slots 335, 340, 345, 350, 355, 360 extending from the trailing edge to a point between the leading edge and the trailing edge. The externally chamfered trailing edge portion 310 is frusto conical in shape, i.e., a shape of a truncated cone. The expanded side AVTR 115 has an internal diameter that is approximately equal to the outer diameter of the expanded end of a tube. The AVTR 115 slides onto the expanded end. The standard side AVTR 135 has an internal diameter that is approximately equal to the outer diameter of the unexpanded end of a tube. The AVTR 135 slides onto the unexpanded end. The AVTR 135 occupies space between the interior of the splice nut, near the distal opening, and the end of the tube. Each AVTR 115, 135 exerts a spring force between the edge of the splice body and the splice nut and between the tube and the splice nut, frictionally resisting rotation of the splice nut. The fingers 315, 320, 325, 365, 370 operate as cantilever beams, which press against the engaged portion of the tube when the nut 125, 140 is tightened. The annular groove 375 facilitates deflection of the fingers 315, 320, 325, 365, 370. The chamfer 310 operates as a wedge, exerting frictional force against the nut 125, 140. The leading-edge annular flange 300 seats within a gap between a threaded end of the splice body 105 and a portion of the tube on which the AVTR is installed, as more clearly shown in FIG. 3.

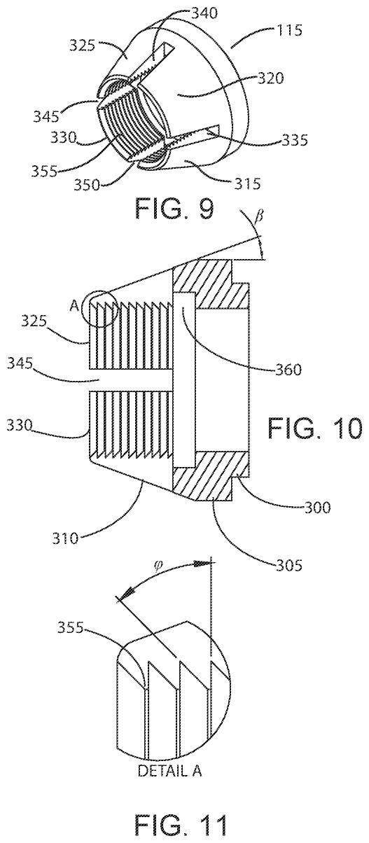

The exemplary AVTR 115 of FIGS. 9-11 include internal knurls 355. The knurls 355 are a series of small ridges, beads or other protuberances on the metal surface to aid in gripping of engaged tube. In addition, an internal annular groove 360 is provided to facilitate bending of fingers 315, 320, 325, 365, 370. Unlike the groove 375 of the AVTR in FIG. 8, which is disposed between the free end and attached of the fingers, the groove 360 is disposes at the attached end of the fingers. In the exemplary embodiment of FIGS. 9-11, the frusto-conical exterior portion of the AVTR is angled at an acute angle to nest within a mating comparting of a nut. By way of example, R may be less than 30°, such as 20°. The exemplary knurls comprise ridges with a first face 356 that is generally perpendicular to the central axis of the AVTR, and an opposite second face 357 at an acute angle relative to the first face 356. For example, φ may be less than 60°, such as 45°.

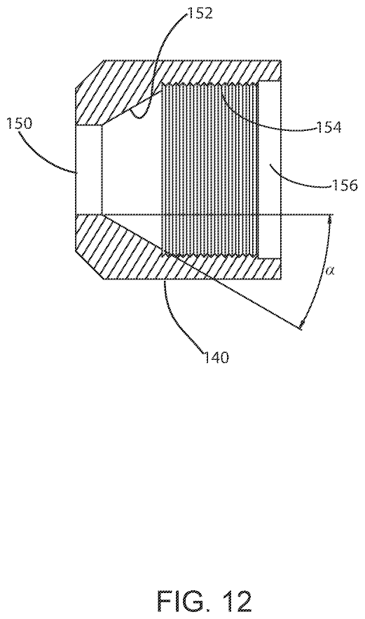

The section view of end nut 140 (FIG. 12) reveals a compartment with a wall 152 angled to mate with the frusto-conical exterior portion of an AVTR, such as AVTR 115. The compartment defined by the wall 152 is frusto-conical in shape. The angle α may be about equal to β, or slightly less (e.g., less by no more than 5°) than R to facilitate deflection of the fingers 315, 320, 325, 365, 370. When in mating engagement, the wall of the compartment and the exterior surface of the frusto-conical exterior portion of the AVTR are in direct contact over substantially their entire surface areas (e.g., over more than half of their entire surface areas, preferably at least two thirds of the entire surface areas, and more preferably at least three quarters of the entire surface areas). Internal threads 154, accessible through proximal open end 156 engage one of the externally threaded nipples 205, 210. As the nut 140 is tightened to a nipple 205, 210, the wall 152 exerts force against the fingers 315, 320, 325, 365, 370, causing the fingers 315, 320, 325, 365, 370 of the AVTR 115 to deflect inwardly (i.e., towards an engaged tube). A tube is received through the open distal end 150 of the nut 140. The inward deflection of 315, 320, 325, 365, 370 of the AVTR 115 creates substantial frictional engagement between the engaged tube and the AVTR 115.

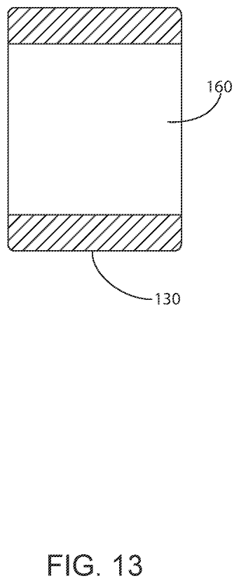

The seal 130 (FIG. 13) is ring-like structure sized to slide onto the unexpanded end of a tube. The central opening 160 of the seal 130 has an internal diameter that is approximately equal to the outer diameter of the unexpanded end of the tube. The seal 130 slides onto the unexpanded end. The seal 130 is sized and shaped to substantially occupy the space between a received portion of the unexpanded end of the tube and the interior of the splice body 105. The thickness of the seal 130 is sufficient to substantially occupy the space, without interfering with installation. When installed, the seal 130 is disposed in the interior at the standard side of the splice body 105. The interior of the standard side of the splice body 105 is shaped and sized to receive the seal 130.

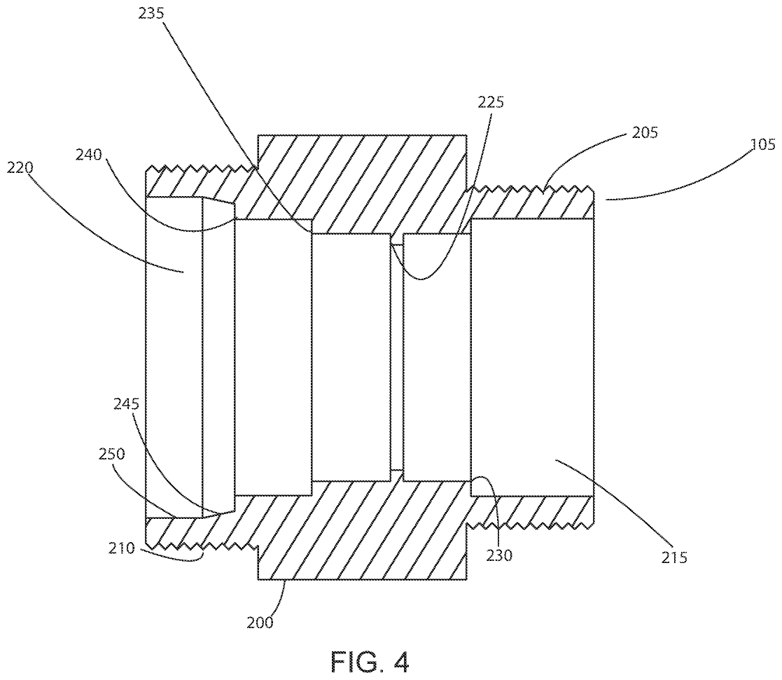

The splice body 105 houses certain components of the splice assembly. The splice nuts 125, 140 for the expanded and standard sides threadedly attach to the slice body 105 at opposite ends. Referring to FIG. 4, the interior and exterior of the splice body include functionally significant structures. Opposed externally threaded nipples 205, 210 engage nuts 125, 140. One nipple 210 is threaded to threadedly engage the splice nut 125 on the expanded side. The other nipple 205 is threaded to threadedly engage the splice nut 140 on the standard side. The intermediate section 200, a portion of the exterior, between the nipples, includes a shape that can be engaged by a wrench. By way of example, a hexagonal cross section intermediate section 200 may be provided between the nipples 205, 210.

The interior of the splice body 105 includes a central channel that extends through the splice body 105, from an opening at the standard end 215 of the splice body to an opening at the opposite end 220, the expanded side of the splice body. Features within the channel provide abutments for inserted components. An interior annular flange 225 is provided between compartments 120, 122 and 131 and between the nipples 205, 210, towards or at the middle of the splice body 105. One or more counterbored shoulders 230, 235, 240 are formed on the interior, on each side of the interior annular flange 225, spaced apart from the interior annular flange. Each shoulder 230, 235, 240 is an annular shelf. In the exemplary embodiment, the expanded side includes two spaced apart shoulders 235, 240, while the standard side includes one shoulder 230. The shoulders 230, 235, 240, which may be formed by counterboring, delimit interior sections of different internal diameters.

A portion 245 of the interior at the expanded side, between the open end 220 and the shoulder 240 is internally chamfered. This chamfered portion 245 mates with the chamfered portion of an AVTR. The portion 250 between the chamfered portion 245 and the open end 220 has a consistent diameter.

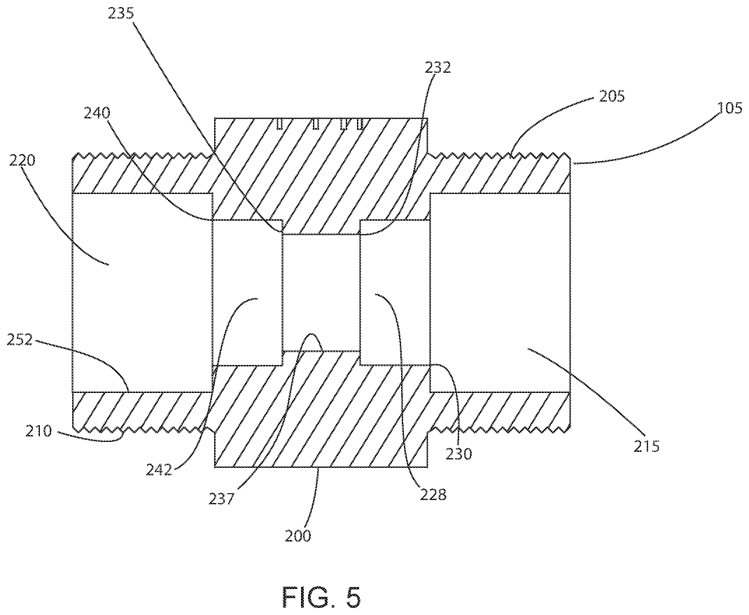

The splice body 105 embodiment of FIG. 5, includes a wider annular interior flange 237 defined between shoulders 232, 235 and compartments 228, 242. The splice body 105 embodiment omits the chamfered portion 245 of the embodiment in FIG. 4. In lieu of the chamfered portion 245, the interior wall 252 extending to the open end 220 defines a space having a constant diameter. The consistent diameter receives the leading-edge annular flange 300 of an AVTR.

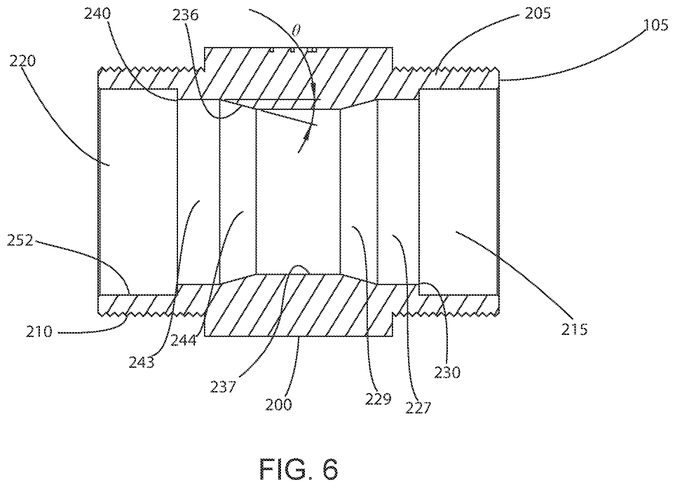

As another embodiment, as shown in FIG. 6, the splice body includes chamfered portions 236, on each side leading to a plateau comprising the annular interior flange 237. The chamfered portions ensure a tight fit for each received tube end. Tubing ends urged into spaces 229, 244 compress under the influence of the chamfered portions 236. Chamfered portions are at an angle of less than 30°. By way of example, θ is from about 2 to 15°.

Any dimensions provided above or in the drawings are nonlimiting examples for a particular embodiment. Other dimensions may be used without departing from the scope of the invention. Varying the dimensions of tubes to be joined or the dimensions of the spacer 120, splice nuts 125, 140, sleeve 110, AVTRs 115, 135, seal 130, may necessitate changes in one or more dimensions of the splice body 105, without departing from the scope of the invention. The assembly 100 is scalable to accommodate various tube sizes.

To use the splice assembly to join a tube with an expanded end to a tube with a standard end, the following steps may be followed. For the expanded side, the spacer 120 is inserted into the expanded end of the tube. The splice nut 125 is slid onto the expanded end of the tube, to about near the transition from unexpanded to expanded tube. The AVTR 115 is slid onto the expanded end of the tube. The sleeve 110 is slid onto the expanded end of the tube and into the expanded side of the splice body 105. The splice nut 125 is then threaded onto the expanded side of the splice body 105. For the standard side, the splice nut 140 is slid onto the standard tube. The AVTR 135 is slid onto the end of the standard tube. The seal 130 is slid onto the end of the standard tube. The splice nut 140 is then threaded onto the standard side of the splice body 105. The standard side may be connected before or after the expanded side. The order of some steps may be varied, as long as the sequence allows connection with the components ordered as shown in the exploded view of FIGS. 1-3.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A splice for hermetically joining a tube with an expanded end to a tube with an end that is sized to mate with the expanded end, the splice comprising:
a splice body with a pair of opposed nipples, including a first nipple and a second nipple, each nipple being externally threaded, the splice body further including a first side and a second side;
a first nut for threadedly engaging the first nipple, the first nut including a first central opening sized to receive an expanded portion of a first tube and a first compartment;
a second nut for engaging the second nipple, the second nut including a second central opening sized to receive an unexpanded portion of a second tube;
a first anti-vibration tension ring configured to surround a first portion of the expanded portion of the first tube;
a sleeve surrounding a first portion of the expanded portion of the first tube;
a second anti-vibration tension ring configured to surround a first portion of the unexpanded portion of the second tube;
a seal surrounding a second portion of the unexpanded portion of the second tube;
the sleeve being contained in the first side of the splice body, and at least a portion of the first anti-vibration tension ring being contained in the first compartment of the first nut, and at least a portion of the second anti-vibration tension ring being contained in the second compartment of the second nut.

2. The splice of claim 1, further comprising a spacer received in the expanded portion of the first tube, a portion of the spacer extending from the expanded portion of the first tube, and the portion of the spacer extending from the expanded portion of the first tube being contained in the first side of the splice body.

3. The splice of claim 1, wherein each antivibration tension ring of the first antivibration tension ring and second antivibration tension ring includes a leading edge and a trailing edge opposite the leading edge, a plurality of fingers defined between spaced apart parallel slots extending from the trailing edge to a point between the leading edge and the trailing edge.

4. The splice of claim 3, wherein each antivibration tension ring of the first antivibration tension ring and second antivibration tension ring includes an interior annular groove between the leading edge and the trailing edge configured to facilitate deflection of the plurality of fingers.

5. The splice of claim 3, wherein each antivibration tension ring of the first antivibration tension ring and second antivibration tension ring includes an interior annular groove between the leading edge and the point between the leading edge and the trailing edge, the interior annular groove being configured to facilitate deflection of the plurality of fingers.

6. The splice of claim 3, wherein an interior surface of each finger of the plurality of fingers includes knurls.

7. The splice of claim 6, wherein the knurls comprise ridges with a first face that is generally perpendicular to a central axis of the antivibration tension ring, and an opposite second face at an acute angle relative to the first face.

8. The splice of claim 7, wherein the acute angle is about 45°.

9. The splice of claim 3, wherein each antivibration tension ring of the first antivibration tension ring and second antivibration tension ring includes a frusto-conical exterior trailing edge portion, an intermediate band, and a leading-edge annular band, the intermediate band being disposed between the frusto-conical exterior trailing edge portion and the leading-edge annular band.

10. The splice of claim 9, wherein the first compartment of the first nut is sized and shaped to matingly receive the frusto-conical exterior trailing edge portion of the first antivibration tension ring; and the second compartment of the second nut is sized and shaped to matingly receive the frusto-conical exterior trailing edge portion of the second antivibration tension ring.

11. The splice of claim 10, wherein the first compartment has a first surface area, and the second compartment has a second surface area, and the first compartment is in direct contact with the frusto-conical exterior trailing edge portion of the first antivibration tension ring over substantially the entire first surface area, and the second compartment is in direct contact with the frusto-conical exterior trailing edge portion of the second antivibration tension ring over substantially the entire second surface area.

12. The splice of claim 11, wherein substantially the entire first surface area is more than half of the first surface area, and substantially the entire second surface area is more than half of the second surface area.

13. A splice for hermetically joining a tube with an expanded end to a tube with an end that is sized to mate with the expanded end, the splice comprising:
a splice body with a pair of opposed nipples, including a first nipple and a second nipple, each nipple being externally threaded, the splice body further including a first side and a second side;
a first nut for threadedly engaging the first nipple, the first nut including a first central opening sized to receive an expanded portion of a first tube and a first compartment;
a second nut for engaging the second nipple, the second nut including a second central opening sized to receive an unexpanded portion of a second tube;
a first anti-vibration tension ring configured to surround a portion of the expanded portion of the first tube;
a second anti-vibration tension ring configured to surround a portion of the unexpanded portion of the second tube;
wherein each antivibration tension ring of the first antivibration tension ring and second antivibration tension ring includes a leading edge and a trailing edge opposite the leading edge, a plurality of fingers defined between spaced apart parallel slots extending from the trailing edge to a point between the leading edge and the trailing edge.

14. The splice of claim 13, wherein each antivibration tension ring of the first antivibration tension ring and second antivibration tension ring includes an interior annular groove between the leading edge and the trailing edge configured to facilitate deflection of the plurality of fingers.

15. The splice of claim 14, wherein each antivibration tension ring of the first antivibration tension ring and second antivibration tension ring includes an interior annular groove between the leading edge and the point between the leading edge and the trailing edge, the interior annular groove being configured to facilitate deflection of the plurality of fingers.

16. The splice of claim 15, wherein an interior surface of each finger of the plurality of fingers includes knurls.

17. The splice of claim 16, wherein the knurls comprise ridges with a first face that is generally perpendicular to a central axis of the antivibration tension ring, and an opposite second face at an acute angle relative to the first face.

18. The splice of claim 17, wherein each antivibration tension ring of the first antivibration tension ring and second antivibration tension ring includes a frusto-conical exterior trailing edge portion, an intermediate band, and a leading-edge annular band, the intermediate band being disposed between the frusto-conical exterior trailing edge portion and the leading-edge annular band.

19. The splice of claim 18, wherein the first compartment of the first nut is sized and shaped to matingly receive the frusto-conical exterior trailing edge portion of the first antivibration tension ring; and the second compartment of the second nut is sized and shaped to matingly receive the frusto-conical exterior trailing edge portion of the second antivibration tension ring.

20. The splice of claim 19, wherein the first compartment has a first surface area, and the second compartment has a second surface area, and the first compartment is in direct contact with the frusto-conical exterior trailing edge portion of the first antivibration tension ring over substantially the entire first surface area, and the second compartment is in direct contact with the frusto-conical exterior trailing edge portion of the second antivibration tension ring over substantially the entire second surface area.
